(19) United States
(12) Patent Application Publication
(10) Pub. No.: US 2014/0375663 A1
(43) Pub. Date: Dec. 25, 2014

(54) INTERLEAVED TILED RENDERING OF STEREOSCOPIC SCENES

(71) Applicant: Alexander Pfaffe, Redmond, WA (US)

(72) Inventor: Alexander Pfaffe, Redmond, WA (US)

(21) Appl. No.: 13/925,459

(22) Filed: Jun. 24, 2013

(51) Int. Cl. G06T 1/60; G06T 15/00

(52) U.S. Cl. CPC G06T 1/60; G06T 15/005
USPC 345/545

(57) ABSTRACT

Embodiments are disclosed that relate to rendering tiles of stereoscopic images in an interleaved manner. For example, one disclosed embodiment provides a method comprising rendering a first tile of an image, and after rendering the first tile of the first image, rendering a first tile of a second image. After rendering the first tile of the second image, a second tile of the first image is rendered, and after rendering the second tile of the first image, a second tile of the second image is rendered. The method further comprises sending the first image to a first eye display, and sending the second image to a second eye display.

### BACKGROUND

In stereoscopic rendering, images of a scene are separately rendered for a user's left and right eyes, wherein perspectives of the left eye image and a perspective of the right eye image are offset similarly to left eye and right eye views of a real world scene. The offset between the left eye image and the right eye image allows the rendered scene to appear as a single three-dimensional scene to a viewer.

### SUMMARY

Embodiments are disclosed that relate to rendering stereoscopic scenes using a tiled renderer. For example, one disclosed embodiment provides a method comprising rendering a first tile of a first image, and after rendering the first tile of the first image, rendering a first tile of a second image. After rendering the first tile of the second image, a second tile of the first image is rendered. After rendering the second tile of the first image, a second tile of the second image is rendered. The method further comprises sending the first image to a first eye display and the second image to a second eye display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example of a stereoscopically rendered scene being viewed with a head-mounted display device.

FIG. 2 schematically shows tiles of left and right images of the stereoscopic scene of FIG. 1.

FIG. 3 shows a block diagram of an embodiment of a memory hierarchy in accordance with the present disclosure.

FIG. 4 shows a flow diagram depicting an embodiment of a method for rendering tiles of images of a stereoscopic scene in an interleaved manner

FIG. 5A schematically shows an order in which tiles of images of a stereoscopic scene are rendered in a non-interleaved manner

FIG. 5B shows a graph of errors between successive tile pairs according to the rendering order of FIG. 5A.

FIG. 6A schematically shows an order in which tiles of images of a stereoscopic scene are rendered in an interleaved manner.

FIG. 6B shows a graph of errors between successive tile pairs according to the rendering order of FIG. 6A.

FIG. 7 shows a block diagram of an embodiment of a computing device in accordance with the present disclosure.

### DETAILED DESCRIPTION

In some approaches to rendering three-dimensional graphics, tiled rendering is used to overcome potential issues associated with the hardware used to perform such rendering, such as limited memory bandwidth. Tiled rendering subdivides an image to be rendered into subimages, successively rendering the subimages until the overall image has been rendered for display.

In stereoscopic rendering, a left and a right image of a scene are separately rendered from different perspectives. When viewed concurrently (or successively at sufficiently high frame rates), the left and right images appear to reproduce the scene in a three-dimensional manner. As two images are rendered, stereoscopic rendering substantially increases (e.g., doubles) the resources utilized to render the three-dimensional scene, including memory bandwidth, time, and power consumption.

Accordingly, embodiments are disclosed herein that relate to decreasing the resources used to render tiles of stereoscopic images. Briefly, the disclosed embodiments relate to rendering a first tile of a second image after rendering a first tile of a first image and prior to rendering a second tile of the first image. As corresponding tiles of left eye and right eye images may have many similar features, interleaved rendering in this manner may reduce memory access penalties by using at least a portion of data associated with the first tile of the first image to render the first tile of the second image.

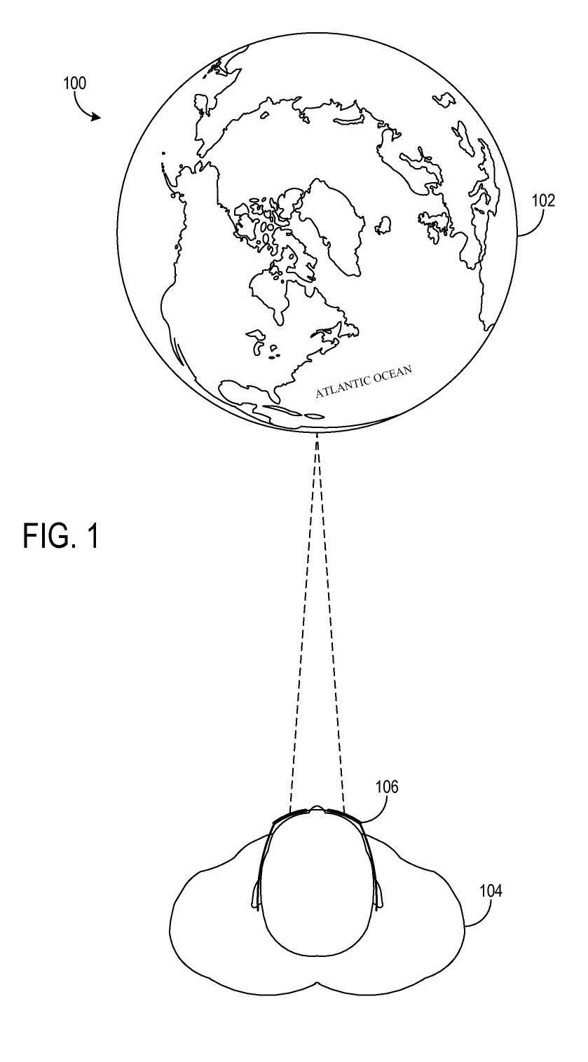

FIG. 1 schematically shows an example of a stereoscopically rendered scene 100 including a stereoscopic object 102 being viewed by a user 104. Stereoscopic scene 100 and stereoscopic object 102 are rendered and displayed in this example by a head-mounted display (HMD) 106 worn by user 104. Here, two images of stereoscopic object 102 are respectively rendered for the left and right eyes of user 104. The images may be respectively rendered from a first perspective and a second perspective that are suitably offset to create a three-dimensional impression.

In the depicted embodiment, the stereoscopic image is viewed by HMD 106. HMD 106 may represent a virtual reality device having a display that substantially occupies the field of view of user 104, such that user 104 perceives content displayed by such an HMD, and not elements of the surrounding physical environment. In another example, HMD 106 may represent an augmented reality device comprising a see-through display with which images may be displayed over a background physical environment.

It will be appreciated that HMD 106 is provided merely as an illustrative example and is not intended to be limiting. In other embodiments, stereoscopic scene 100 and stereoscopic object 102 may be presented via a display device not mounted to the head of user 104. For example, a display device may present an image of stereoscopic object 102 which is then partitioned into separate left and right images by polarized lenses in a frame worn by user 104. Alternatively, the display device may alternately display left and right images of stereoscopic object 102 at relatively high speeds (e.g., 120 frames per second). The left and right images may be selectively blocked and transmitted to user 104 via shutter glasses synced to the frame rate of the display output such that only one of the left and right images is perceived at a given instant.

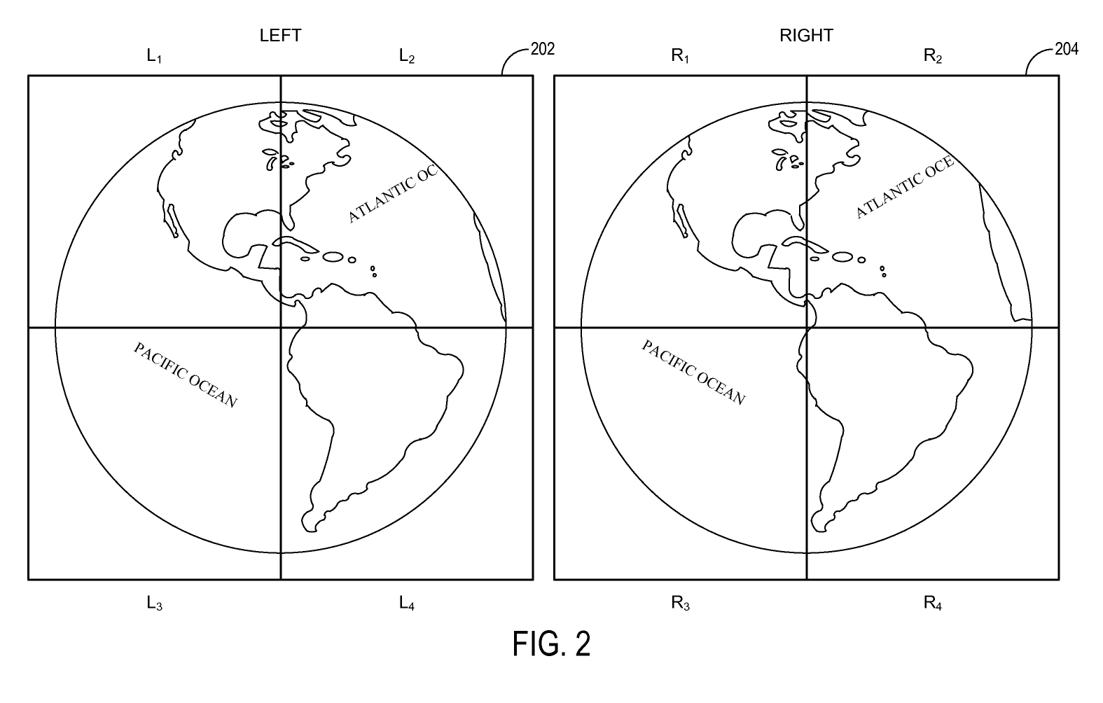

FIG. 2 shows examples of a left image 202 and a right image 204 of a stereoscopic pair of images. Left and right images 202 and 204 show stereoscopic scene 100 and stereoscopic object 102 from the perspective of the left and right eyes of user 104, respectively. In this example, the first and second perspectives are angularly offset from each other by an offset angle such that a greater leftward portion of stereoscopic object 102 is visible in left image 202, while a greater rightward portion of object 102 is visible in right image 204.

FIG. 2 also schematically illustrates the tiled rendering of left and right images 202 and 204. As mentioned above, a tiled renderer may help to mitigate hardware constraints that may exist in some devices. For example, a buffer (e.g., frame buffer) to which output from a renderer is written may be too small to store the entirety of the rendered output for a given image of a scene. A tiled renderer thus may be used to subdivide an image of a scene to be rendered into tiles such that the rendered output of a single tile occupies the buffer at any given time. Once written to the buffer, the rendered output for the tile may be sent to a display device before rendering another tile. Alternatively, the rendered output of a given tile may be written to another location in memory (e.g., another buffer) before another tile is rendered. In some implementations, use of a tiled renderer may facilitate rendering parallelism, as each tile may be rendered independently.

In the depicted example, the tiled renderer has subdivided left and right images 202 and 204 into four equal, rectangular tiles. It will be appreciated, however, that left and right images 202 and 204 may be subdivided into virtually any number of tiles of any suitable shape.

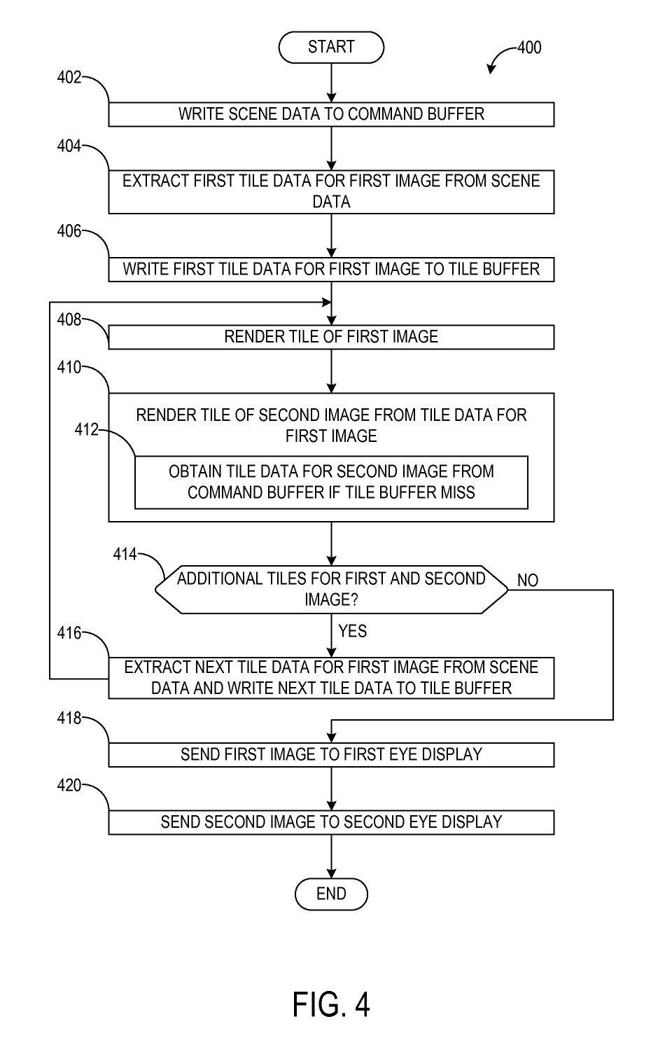

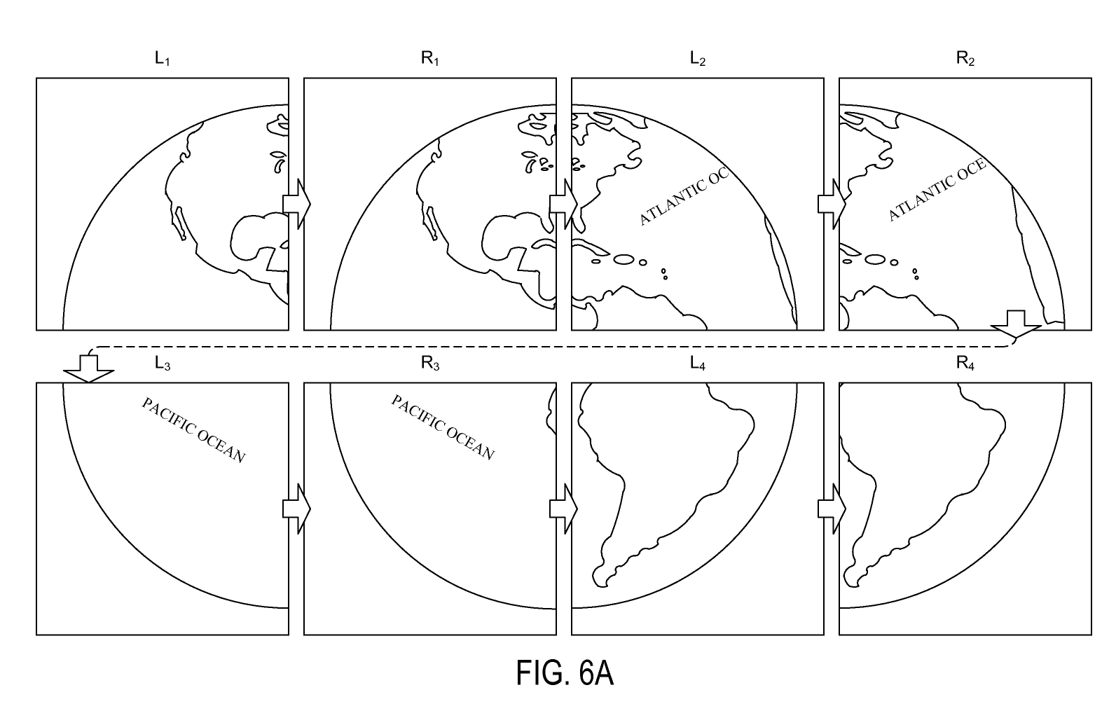

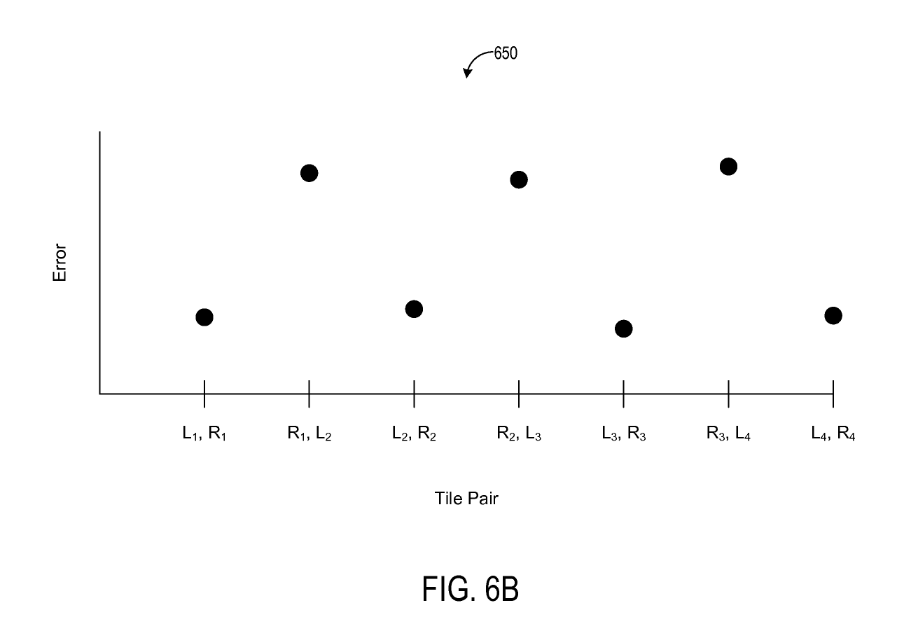

Left image 202 comprises four tiles successively designated in a clockwise direction: L₁, L₂, L₃ and L₄. Likewise, right image comprises four tiles successively designated in the clockwise direction: R₁, R₂, R₃, and R₄. As shown, each set of four tiles for a corresponding image (e.g., L₁, L₂, L₃ and L₄ for left image 202) includes substantially different elements of stereoscopic scene 100 and stereoscopic object 102. In contrast, spatially corresponding tile pairs between left and right images 202 and 204 (e.g., L₁ and R₁, L₂ and R₂, L₃ and R₃, and L₄ and R₄) include substantially similar elements of stereoscopic scene 100 and stereoscopic object 102, as they correspond to substantially similar regions of the scene and object but have an angular offset, as described above. Such tile pairs may be said to be substantially spatially coherent. The spatial coherence of such tile pairs may be leveraged to reduce the time, power, and memory access associated with rendering left and right images 202 and 204 as described in further detail below with reference to FIGS. 4, 6A, and 6B.

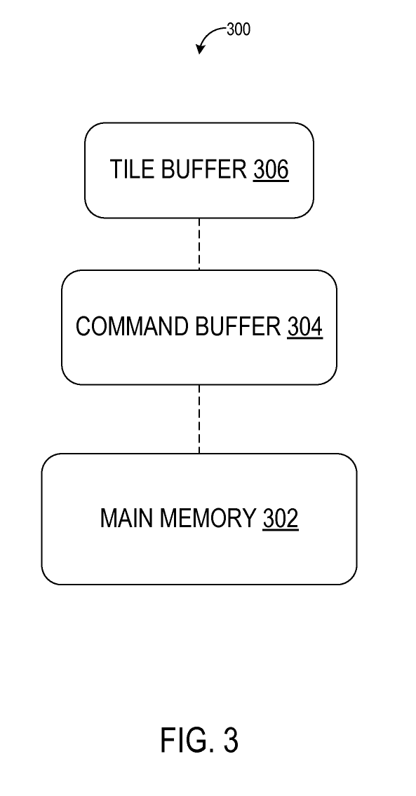

FIG. 3 shows an example memory hierarchy 300 that may be utilized in a tile-based rendering pipeline for rendering left and right images 202 and 204. Hierarchy 300 includes main memory 302. Main memory 302 may have the highest capacity, but also the highest latency, wherein “latency” refers to the time at which data is available following a request for that data in memory. Prior to or during execution of the rendering pipeline with which left and right images 202 and 204 are rendered, data used for rendering stereoscopic scene 100 and stereoscopic object 102 may be written to main memory 302. Such scene data may include, for example, rendering engine and other application code, primitive data, textures, etc.

Memory hierarchy 300 further includes a command buffer 304 operatively coupled to main memory 302 via a bus, represented in FIG. 3 by a dashed line. In this example, command buffer 304 occupies a smaller, separate region of memory and may have a reduced latency compared to that of main memory 302. Requests for data in command buffer 304 may thus be satisfied in a shorter time. Data for one (or in some embodiments, both) of left and right images 202 and 204 may be written to command buffer 304 from main memory 302 such that the data may be accessed by the rendering pipeline in an expedited manner. This data may include the command programs, associated parameters, and any other resources required to render the image, including but not limited to shaders, constants, textures, a vertex buffer, index buffer, and a view transformation matrix or other data structure encoding information regarding a perspective from which the image (e.g., left image 202) is to be rendered,

Memory hierarchy 300 also includes a tile buffer 306 operatively coupled to command buffer 304 via a bus represented by a dashed line. Tile buffer 306 may occupy a smaller, separate region of memory and may have a reduced latency compared to that of command buffer 304. Data for a particular tile (e.g., L₁) may be written to tile buffer 306 from command buffer 304 such that data for the particular tile may be accessed by the rendering pipeline and the tiled renderer in a further expedited manner Tile buffer 306 may be configured to store an entirety of tile data for a given tile and a given tile size.

In some embodiments, command buffer 304 and tile buffer 306 occupy regions of a first cache and a second cache respectively allocated to the buffers. The first cache may have a first latency, while the second cache may have a second latency which may be less than the first latency. In this way, memory fetches for tile data may be optimized and latency penalties resulting from tile data fetches reduced.

It will be appreciated that main memory 302, command buffer 304, and tile buffer 306 may each correspond to a discrete, physical memory module which may be operatively coupled to a logic device. Alternatively, one or more of main memory 302, command buffer 304, and tile buffer 306 may correspond to a single physical memory module, and may be further embedded with a logic device in a system-on-a-chip (SoC) configuration. Moreover, the busses which facilitate reads and writes among main memory 302, command buffer 304, and tile buffer 306 are exemplary in nature. In other embodiments, for example, tile buffer 306 may be operatively and directly coupled to main memory 302.

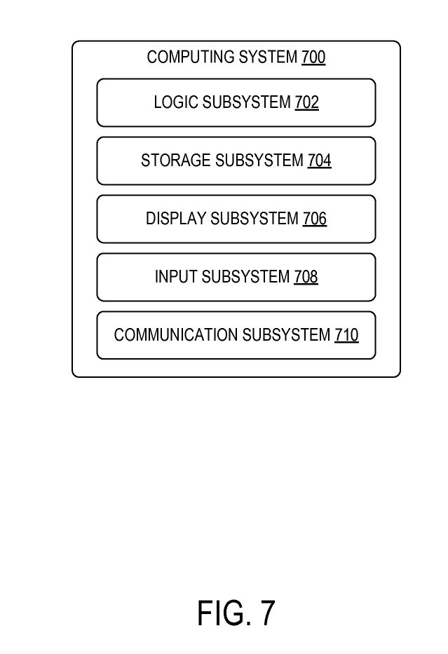

FIG. 4 shows a flow diagram depicting an embodiment of a method 400 for rendering tiles of images of a stereoscopic scene in an interleaved manner. Method 400 is described with reference to stereoscopic scene 100 left and right images 202 and 204 and their constituent tiles, and memory hierarchy 300. However, it will be understood that the method may be used in any other tiled rendering scenario and hardware environment in which a common scene is rendered from two or more perspectives. Examples of suitable hardware are described in more detail below with reference to FIG. 7.

At 402, method 400 comprises writing scene data for stereoscopic scene 100 to command buffer 304 from main memory 302. As described above, the scene data may comprise a plurality of elements for rendering stereoscopic scene 100 and stereoscopic object 102, such as primitives which model the substantially spherical shape of the object, textures which affect the surface appearance of the object, etc. It will be appreciated that prior to 402, such scene data, along with other data such as rendering pipeline and other application code, may be written to main memory 302 such that command and tile buffers 304 and 306 may read the scene data from main memory.

At 404, method 400 comprises extracting first tile data for a first image from the scene data written to command buffer. For example, tile data associated with tile L₁ of left image 202 may be extracted from the scene data. The tile data may be a subset of the scene data, comprising primitives, textures, etc. corresponding to the first tile but not other tiles of the left image. Extraction of the first tile data may include actions such as a clipping, scissor, or occlusion culling operation to determine the scene data specific to the first tile. Method 400 further comprises, at 406, writing the first tile data for the first image to tile buffer 306.

At 408, the first tile (e.g., L₁) of the first image (e.g., left image 202) is rendered. As described above, rendering may include transformation, texturing, shading, etc. which collectively translate first tile data into data which may be sent to a display device (e.g., HMD 106) to produce an observable image (e.g., stereoscopic scene 100 observed by user 104).

Next, at 410, a first tile (e.g., R₁) of a second image (e.g., right image 204) is rendered based on the tile data previously written to and currently occupying tile buffer 306 for the first image tile. Here, the potentially substantial spatial coherence between the spatially corresponding tile pair L₁-R₁ is utilized, as a significant portion of L₁ already written to tile buffer 306 may be reused to render R₁. In this way, the time, processing resources, power, etc., which might be otherwise doubled in rendering two dissimilar image tiles of a stereoscopic scene, may be reduced. More particularly, rendering a tile (e.g., R₁) of a second image (e.g., right image 204) after rendering a spatially corresponding tile (e.g., L₁) of a first image (e.g., left image 202) may result in a reduced number of memory fetches to command buffer 304, compared to rendering all tiles (e.g., L₁-L₄) of the first image before rendering the first tile (e.g., R₁) of the second image.

It will be appreciated that, prior to performing process 410, the view transformation matrix described above, which may reside in command buffer 304, may be utilized to redetermine the perspective from which the second image (e.g., right image 204) is rendered.

In some instances, some data used for rendering of the first tile of the second image may not be in the tile buffer (e.g. due to the slightly different perspectives of stereoscopic images). Thus, after rendering at least a portion of the first tile of the second image using the tile data in the tile buffer, and prior to rendering the second tile of the first image, a remaining portion of the first tile of the second image may be rendered based on tile data in the command buffer if a tile buffer miss occurs during rendering of the first tile of the second image. This is illustrated at 412, where tile data (e.g., data for R₁) for the second image (e.g., right image 204) is obtained from command buffer 304 if there is a miss for the tile data in tile buffer 306. In embodiments in which tile buffer 306 occupies a cache, the tile buffer miss corresponds to a cache miss. In some scenarios, access to command buffer 304 may be omitted, as the tile data already written to tile buffer 306 at 406 is sufficient to fully render this tile.

At 414, method 400 comprises determining whether there are additional tiles for the first and second images which have yet to be rendered. If there are no additional tiles for the first and second images which have yet to rendered, then method 400 proceeds to 418, where the first image is sent to the first eye display and the second image is sent to the second eye display.

On the other hand, if there are additional tiles for the first and second images which have yet to rendered, then method 400 proceeds to 416 where tile data for the next tile (e.g., L₂) for the first image (e.g., left image 202) is extracted from scene data in command buffer 304 as at 404. Following tile data extraction for the next tile for the first image, the next tile is rendered as at 408. Method 400 thus proceeds iteratively until all tiles of the first and second images have been rendered, at which point the first and second images are sent respectively to the first eye display and the second eye display. It will be appreciated that the first and second images sent to respective eye displays at 418 and 420 may be performed concurrently or successively as described above. Further, the first and second eye displays may be separate display devices or form a contiguous display device, and may be part of a wearable display device such as HMD 106 or a non-wearable display device such as a computer display (e.g. monitor, tablet screen, smart phone screen, laptop screen, etc.).

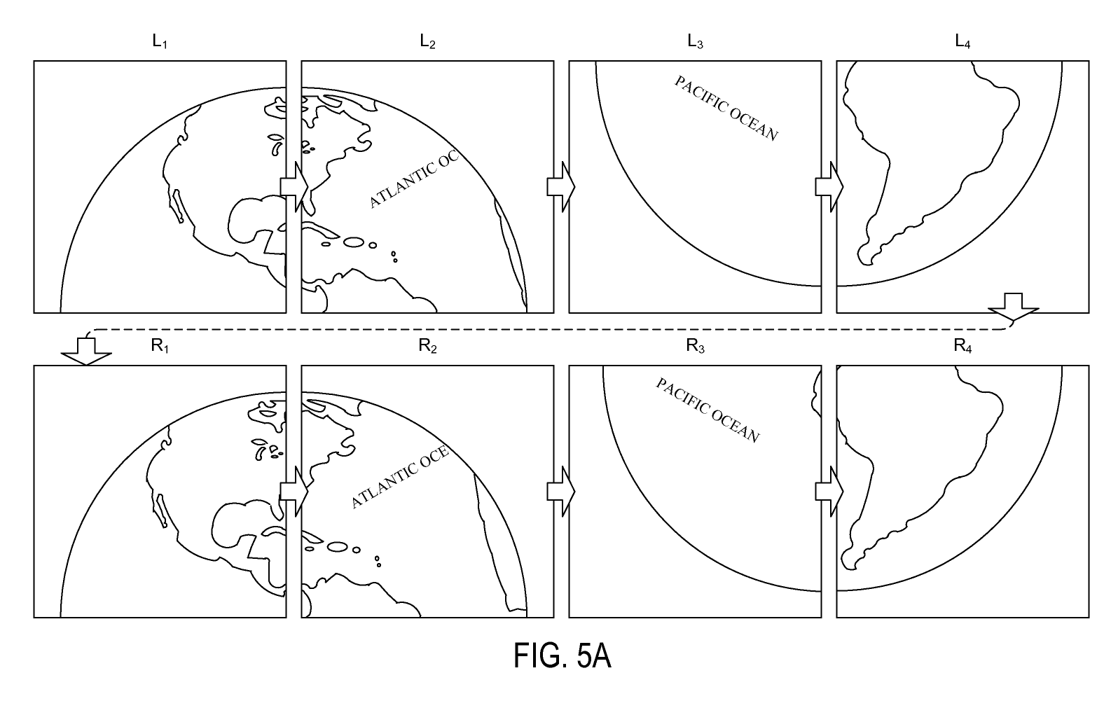

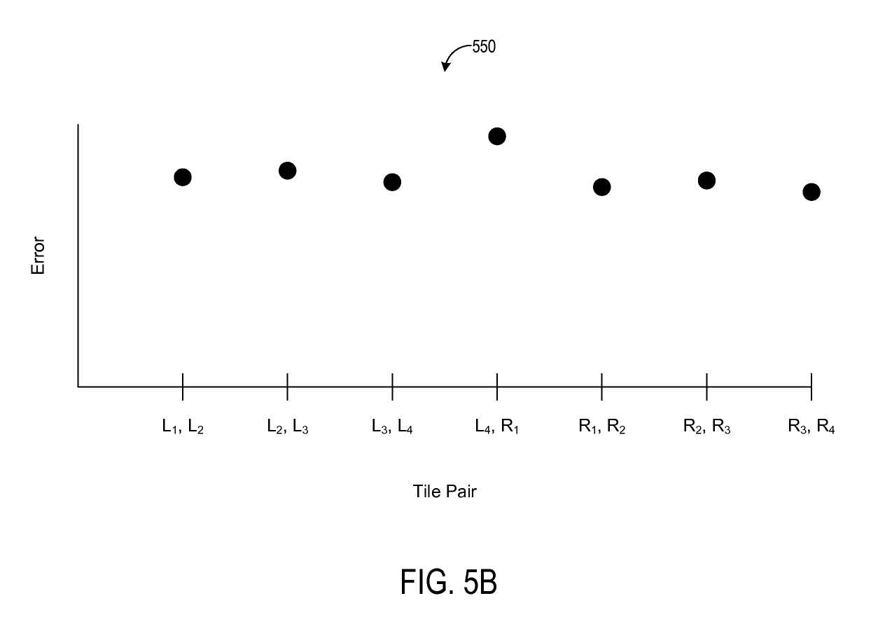

The potential savings of computing resources that may be achieved by following method 400 is demonstrated via FIGS. 5A-5B and FIGS. 6A-6B, wherein FIGS. 5A and 5B show non-interleaved tiled rendering of stereoscopic images and FIGS. 6A-6B show an example of tiled rendering of stereoscopic images according to method 400.

First regarding FIGS. 5A-5B, the tile set for left image 202 is successively rendered in the order L₁, L₂, L₃, L₄. After the tile set for left image 202 has been rendered, the entire tile set for right image 204 is successively rendered in the order R₁, R₂, R₃, R₄. In this approach, the spatial coherency between spatially corresponding tile pairs of two images is not leveraged. As such, a substantially entire set of data is written to the tile buffer for each rendered tile. Consequently, stereoscopic rendering of two images of a scene (e.g., scene 100) in this approach may utilize roughly double the computing resources compared to rendering of a single image of the same scene.

FIG. 5B shows a graph 550 of image error computed between each successive tile pair of left and right images 202 and 204 according to the order in which the tiles are rendered based on the approach represented in FIG. 5A. As illustrated, the error between each successive tile pair may fluctuate about a relatively high error value, indicating significant differences in the image content between successive tile pairs. It will be appreciated that error graph 550 is provided as an illustrative example, and that similar error graphs produced using the rendering approach of FIG. 5A may display greater or lesser errors between successive tiles depending on the visual content of the tiles being rendered.

Error graph 550 may also represent a relative amount of data copied from command buffer 304 to tile buffer 306 when rendering the second tile of each adjacent pair of tiles—for example, the error value corresponding to the L₄, R₁ pair may represent the amount of data copied to the tile buffer when rendering tile R₁ after rendering tile L₄. Although in some instances a portion of the second tile of each tile pair may be rendered based on data residing in tile buffer 306 previously written in order to render the first tile (e.g., corresponding to a cache hit), in this example a majority of the tile data required to render the second tile is copied from command buffer 304 to tile buffer 306 (e.g., corresponding to a cache miss).

Next, FIG. 6A shows the order in which the tiles of left and right images 202 and 204 of FIG. 2 are rendered according to method 400 of FIG. 4. Here, tiles are rendered in an interleaved manner based on spatial coherence in the following manner: L₁, R₁, L₂, R₂, L₃, R₃, L₄, and R₄. By rendering the tiles of left and right images 202 and 204 in this order, tile data already written to tile buffer 306 (FIG. 3) in order to render the first tile of a spatially corresponding tile pair is leveraged when rendering the second tile of the tile pair. Accordingly, the computational cost (e.g., time, power, etc.) incurred during rendering images of a stereoscopic scene may be significantly reduced, and in some instances potentially by a factor of close to two.

FIG. 6B shows a graph 650 illustrating image error computed between adjacent tiles according to the order in which the tiles are rendered based on the approach of FIGS. 4 and 6A. Due to interleaved rendering, the error alternates between a greater relative error and a lesser relative error (relative to each other), starting at a lesser error due to the spatial correspondence between tiles L₁ and R₁.

Graph 650 may also represent the amount of data copied from command buffer 304 to tile buffer 306 (FIG. 3) when rendering the second tile of each pair. For example, a relatively low amount of data is copied to tile buffer 306 when rendering tile R₁ following rendering tile L₁, as a substantial portion of tile data previously copied to the tile buffer for rendering tile L₁ is reused to render R₁. Conversely, a relatively low amount of data previously written to and residing in tile buffer 306 may be leveraged when rendering tile pairs which do not spatially correspond—for example when rendering tile L₂ after rendering tile R₁.

Thus, the disclosed embodiments may allow for the efficient use of computing resources when performing tiled rendering of stereoscopic images. In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic subsystem 702 and a storage subsystem 704. Computing system 700 may optionally include a display subsystem 706, input subsystem 708, communication subsystem 710, and/or other components not shown in FIG. 7.

Logic subsystem 702 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors configured to execute software instructions. Additionally or alternatively, the logic subsystem may include one or more hardware or firmware logic subsystems configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 704 includes one or more physical devices comprising computer-readable storage media configured to hold instructions executable by the logic subsystem to implement the methods and processes described herein. When such methods and processes are implemented, the state of storage subsystem 704 may be transformed—e.g., to hold different data.

Storage subsystem 704 may include removable and/or built-in devices. Storage subsystem 704 may include optical memory (e.g., CD, DVD, HD-DVD, Blu-Ray Disc, etc.), semiconductor memory (e.g., RAM, EPROM, EEPROM, etc.) including memory hierarchy 300 of FIG. 3, one or more caches (e.g., level 1 cache, level 2 cache, etc.) and/or magnetic memory (e.g., hard-disk drive, floppy-disk drive, tape drive, MRAM, etc.), among others. Storage subsystem 704 may include volatile, nonvolatile, dynamic, static, read/write, read-only, random-access, sequential-access, location-addressable, file-addressable, and/or content-addressable devices.

It will be appreciated that storage subsystem 704 includes one or more physical devices and excludes propagating signals per se. However, aspects of the instructions described herein alternatively may be propagated by a communication medium (e.g., an electromagnetic signal, an optical signal, etc.), as opposed to being stored in a computer-readable storage medium.

Aspects of logic subsystem 702 and storage subsystem 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 700 implemented to perform a particular function. In some cases, a program may be instantiated via logic subsystem 702 executing instructions held by storage subsystem 704. It will be understood that different programs may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

Display subsystem 706 may be used to present a visual representation of data held by storage subsystem 704. As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology, including but not limited to HMD 106 of FIG. 1. Such display devices may be combined with logic subsystem 702 and/or storage subsystem 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method for producing a stereoscopic image using a tiled renderer, the stereoscopic image comprising a first image of a scene from a first perspective and a second image of the scene from a second perspective, the method comprising:
rendering a first tile of the first image;
after rendering the first tile of the first image, rendering a first tile of the second image;
after rendering the first tile of the second image, rendering a second tile of the first image;
after rendering the second tile of the first image, rendering a second tile of the second image; and
sending the first image to a first eye display and sending the second image to the second eye display.

2. The method of claim 1, further comprising:
prior to rendering the first tile of the first image, copying data associated with the first image and the second image to a command buffer in a memory cache.

3. The method of claim 2, further comprising:
prior to rendering the first tile of the first image, and after copying the data to the command buffer, copying data associated with the first tile of the first image from the command buffer to a tile buffer.

4. The method of claim 3, wherein the first tile of the second image is rendered at least partially based on the data associated with the first tile of the first image.

5. The method of claim 4, wherein a remaining portion of the first tile of the second image is rendered based on data in the command buffer if a tile buffer miss occurs.

6. The method of claim 1, wherein an error computed between successive pairs of tiles alternates between a greater error and a lesser error.

7. The method of claim 2, wherein rendering the first tile of the second image results in a reduced number of memory fetches to the command buffer compared to rendering all tiles of the first image before rendering the first tile of the second image.

8. The method of claim 1, wherein rendering the first tile of the second image includes redetermining a view transformation matrix compared to rendering the first tile of the first image.

9. On a computing device, a method for rendering a stereoscopic image of a scene, the stereoscopic image comprising a first image and a second image, the method comprising:
writing scene data to a command buffer;
extracting first tile data for the first image from the scene data;
writing the first tile data for the first image to a tile buffer;
rendering a first tile of the first image based on the first tile data for the first image;
rendering a first tile of the second image, wherein at least a portion of the first tile of the second image is rendered based on the first tile data for the first image in the tile buffer; and
after rendering the first tile of the second image, rendering a second tile of the first image.

10. The method of claim 9, further comprising, after rendering at least a portion of the first tile of the second image and prior to rendering the second tile of the first image, rendering a remaining portion of the first tile of the second image based on tile data in the command buffer if a tile buffer miss occurs during rendering of the first tile of the second image.

11. The method of claim 9, further comprising:
prior to writing the scene data to the command buffer, allocating at least a portion of a first cache to the command buffer; and
prior to writing the first tile data for the first image to the tile buffer, allocating at least a portion of a second cache to the tile buffer;
wherein the first cache has a first latency and the second cache has a second latency, the second latency less than the first latency.

12. The method of claim 9, wherein the first image and the second image correspond to a first perspective and a second perspective, respectively, the first perspective at least partially overlapping the second perspective.

13. The method of claim 12, wherein the first perspective is separated from the second perspective by an offset angle.

14. The method of claim 9, wherein the tile buffer is configured to store an entirety of tile data for a given tile.

15. The method of claim 9, further comprising outputting the first image and the second image to a left eye display and a right eye display, respectively.

16. The method of claim 9, wherein an error computed between successive pairs of tiles alternates between a greater error and a lesser error.

17. On a computing device, a method for rendering a stereoscopic image, the stereoscopic image comprising a first image and a second image, the method comprising:
subdividing the first image and the second image into a plurality of tiles; and
rendering the plurality of tiles in an interleaved manner such that a tile of the second image is rendered following rendering of a tile of the first image, and such that an error computed between successive pairs of tiles alternates between a greater relative error and a lesser relative error.

18. The method of claim 17, wherein the first image and the second image correspond to a first perspective and a second perspective, respectively, the first perspective angularly separated from the second perspective by an offset angle.

19. The method of claim 17, further comprising outputting the first image and the second image to a left eye display and a right eye display, respectively.

20. The method of claim 17, wherein the tile of the second image spatially corresponds to the tile of the first image.
